(19) United States
(12) Patent Application Publication
(10) Pub. No.: US 2017/0329797 A1
(43) Pub. Date: Nov. 16, 2017

(54) HIGH-PERFORMANCE DISTRIBUTED STORAGE APPARATUS AND METHOD

(71) Applicant: ELECTRONICS AND TELECOMMUNICATIONS RESEARCH INSTITUTE, Daejeon (KR)

(72) Inventors: Hyun Hwa CHOI, Daejeon (KR); Byoung Seob KIM, Sejong (KR); Won Young KIM, Daejeon (KR); Seung Jo BAE, Daejeon (KR)

(21) Appl. No.: 15/203,679

(22) Filed: Jul. 6, 2016

(30) Foreign Application Priority Data
May 13, 2016 (KR) 10-2016-0058667

(51) Int. Cl. G06F 17/30; H04L 29/08

(52) U.S. Cl. CPC G06F 17/30203; H04L 67/06; G06F 17/30091; G06F 17/30117; G06F 17/30138

(57) ABSTRACT

Provided are a high-performance distributed storage apparatus and method. The high-performance distributed storage method includes receiving and storing file data by a chunk unit, outputting file data chunks stored in an input buffer and transmitting the file data chunks to data servers in parallel, additionally generating a new file storage requester to connect the new file storage requester to a new data server based on a data input speed of the input buffer and a data output speed at which data is output to the data server, re-setting a file data chunk output sequence for a plurality of file storage requesters including the new file storage requester, and applying a result of the re-setting to output and transmit the file data chunks stored in the input buffer to the data servers in parallel.

### CROSS-REFERENCE TO RELATED APPLICATIONS

This application claims priority under 35 U.S.C. §119 to Korean Patent Application No. 10-2016-0058667, filed on May 13, 2016, the disclosure of which is incorporated herein by reference in its entirety.

### TECHNICAL FIELD

The present invention relates to a distributed file system, and more particularly, to an apparatus and a method for distributedly storing large-scale data at a high speed.

### BACKGROUND

Generally, a distributed file system is a system that distributedly stores and manages metadata and actual data of a file. The metadata is attribute information describing the actual data and includes information about a data server which stores the actual data. The distributed file system has a distributed structure where a metadata server is fundamentally connected to a plurality of data servers over a network. Therefore, a client accesses metadata of a file stored in the metadata server to obtain information about a data server storing actual data, and accesses a plurality of data servers corresponding to the obtained information to input/output the actual data.

Actual data of a file is distributedly stored by a chunk unit having a predetermined size in data servers which are connected to each other over a network. When a file to be processed is a file having a size larger than a predetermined chunk size, a conventional distributed file system previously determines how many data servers file data is distributed to and stored in, and stores the file data in parallel, thereby enhancing performance. Such a distributed storage method is referred to as file striping, and the file striping may be set by a file unit or a directory unit.

In this context, Korean Patent Registration No. 10-0834162 (data storing method and apparatus using striping) discloses clusters of NFS servers and a data storing apparatus including a plurality of storage arrays which are communicating with the servers. Here, each of the servers uses a striped file system for storing data, and includes network ports for cluster traffic between incoming file system requests and servers.

When the data storage performance of the distributed file system cannot satisfy data storage (or input) performance desired by an application, file data is lost, or storing of data fails, causing a failure of application execution. Particularly, high-speed data storage performance is necessary for stably processing large-scale data (for example, scientific data such as space weather measurement data, hadron collider data, large cosmology simulation data, etc.).

However, the conventional distributed file system has a limitation in that when processing large-scale data, the data is sampled and distributedly stored without the original file being stored as-is. For example, in Lustre that is a representative distributed parallel file system of the related art, single file data input/output performance is about 6 Gbps, and the requirement performance of a hadron collider is about 32 Gbps. That is, storage performance which is far faster than the distributed storage performance of the conventional distributed file system is needed efficiently distributing and storing large-scale data.

### SUMMARY

Accordingly, the present invention provides a high-performance distributed storage apparatus and method that increase storage parallelism of file data with respect to a plurality of data servers to distributedly store large-scale data at a high speed.

The objects of the present invention are not limited to the aforesaid, but other objects not described herein will be clearly understood by those skilled in the art from descriptions below.

In one general aspect, a high-performance distributed storage apparatus, based on a distributed file system including a metadata server and a data server, includes: an input buffer, file data being input to the input buffer by a chunk unit; two or more file storage requesters configured to output file data chunks stored in the input buffer and transmit and store the file data chunks to and in different data servers in parallel; and a high-speed distributed storage controller configured to additionally generate a new file storage requester, based on a data input speed of the input buffer and a data output speed at which data is output to the data servers and delete at least one chunk of the file data stored in the input buffer, based on a predetermined remaining storage space of the input buffer.

In another general aspect, a high-performance distributed storage method, performed by a high-performance distributed storage apparatus based on a distributed file system including a metadata server and a data server, includes: receiving and storing, by an input buffer, file data by a chunk unit; outputting, by two or more file storage requesters connected to different data servers, file data chunks stored in the input buffer and transmitting the file data chunks to the connected data servers in parallel; additionally generating, by a high-speed distributed storage controller, a new file storage requester to connect the new file storage requester to a new data server, based on a data input speed of the input buffer and a data output speed at which data is output to the data server; re-setting, by the high-speed distributed storage controller, a file data chunk output sequence for a plurality of file storage requesters including the new file storage requester; and applying, by the plurality of file storage requesters, a result of the re-setting to output and transmit the file data chunks stored in the input buffer to the connected data servers in parallel.

Other features and aspects will be apparent from the following detailed description, the drawings, and the claims.

### BRIEF DESCRIPTION OF THE DRAWINGS

FIG. 1 is a diagram illustrating a structure of a distributed file system according to an embodiment of the present invention.

FIG. 2 is a diagram for describing an example of file striping based on a distributed file method according to an embodiment of the present invention.

FIG. 3 is a diagram for describing another example of file striping based on a distributed file method according to an embodiment of the present invention.

FIG. 4 is a diagram for describing a component of metadata when changing file striping according to an embodiment of the present invention.

FIG. 5 is a flowchart for describing a file striping change operation when distributedly storing file data, according to an embodiment of the present invention.

FIG. 6 is a flowchart for describing a file data chunk deleting operation when distributedly storing file data, according to an embodiment of the present invention.

FIG. 7 is a flowchart for describing an operation of storing a file data chunk in a data server, according to an embodiment of the present invention.

### DETAILED DESCRIPTION OF EMBODIMENTS

Hereinafter, embodiments of the present invention will be described in detail to be easily embodied by those skilled in the art with reference to the accompanying drawings. The present invention may, however, be embodied in many different forms and should not be construed as being limited to the embodiments set forth herein. The present invention may, however, be embodied in many different forms and should not be construed as being limited to the embodiments set forth herein. In the accompanying drawings, a portion irrelevant to a description of the present invention will be omitted for clarity. Like reference numerals refer to like elements throughout.

In this disclosure below, when it is described that one comprises (or includes or has) some elements, it should be understood that it may comprise (or include or has) only those elements, or it may comprise (or include or have) other elements as well as those elements if there is no specific limitation.

Hereinafter, a high-performance distributed storage apparatus and method according to an embodiment of the present invention will be described in detail with reference to the accompanying drawings.

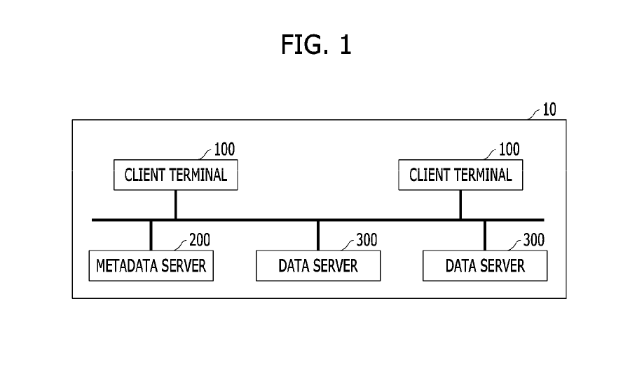

FIG. 1 is a diagram illustrating a structure of a distributed file system 10 according to an embodiment of the present invention.

As illustrated in FIG. 1, the distributed file system 10 may include a client terminal 100, a metadata server 200, and a data server 300. For reference, the client terminal 100 and the data server 300 may each be provided in plurality, and the plurality of client terminals 100 and the plurality of data servers 300 may be connected to the metadata server 200 over a network.

The client terminal 100 may execute a client application. As the client application is executed, data may be generated and distributedly stored.

At this time, the client terminal 100 may access file metadata stored in the metadata server 200 to obtain the file metadata and may access a corresponding data server 300 based on the obtained file metadata to input/output file data.

The metadata server 200 may manage metadata about all files of the distributed file system 10 and status information about all of the data servers 300. Here, the metadata may be data describing the file data and may include information about a corresponding data server 300 that stores the file data.

The data server 300 may store and manage data by a chunk unit having a predetermined size.

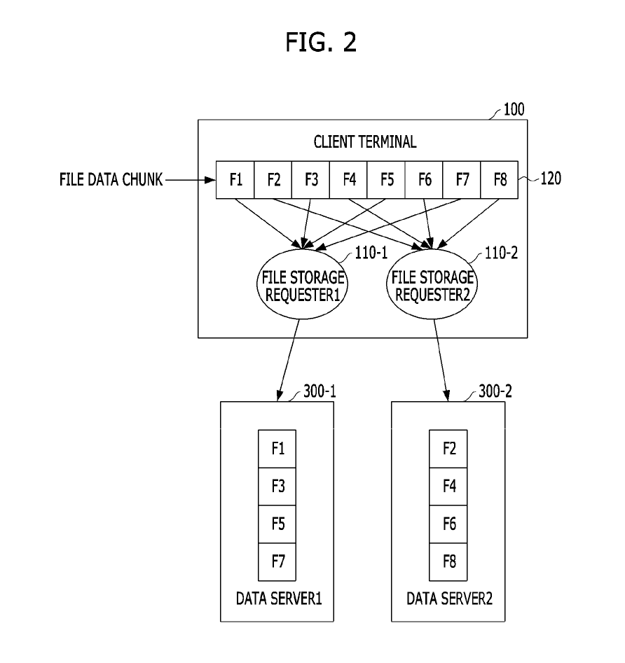

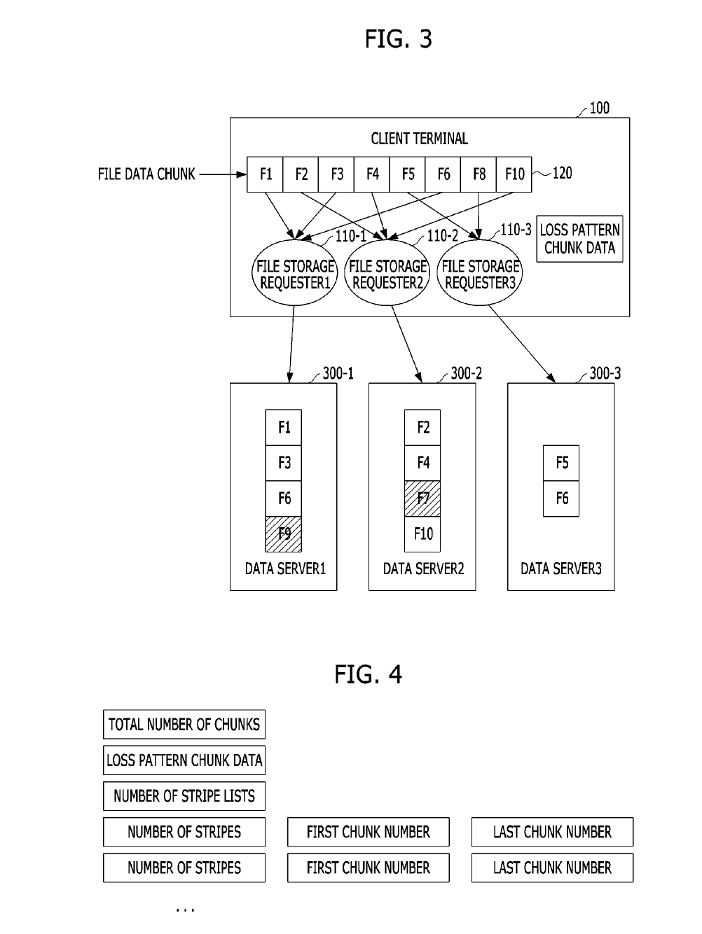

FIG. 2 is a diagram for describing an example of file striping based on a distributed file method according to an embodiment of the present invention. FIG. 3 is a diagram for describing another example of file striping based on a distributed file method according to an embodiment of the present invention.

In FIGS. 2 and 3, an operation of distributing and storing file data of a client terminal 100 to and in a plurality of data servers 300 in parallel is illustrated. In this case, the number of the data servers 300 for distributedly storing the file data may be referred to as the number of file stripes. The number of file stripes may be determined when the client terminal 100 generates a file, and an initial value may be set as an arbitrary setting value which is previously set, or may be selectively set by a user.

In detail, when opening a file, the client terminal 100 may generate a plurality of file storage requesters 110 corresponding to the number of file stripes which is previously set. For reference, the file storage requester 110 may be a processing program, and as a processing unit (i.e., a file storage requesting unit) that processes an operation of a predetermined algorithm or process, the file storage requesters 110 may transfer and store the file data of the client terminal 100 to and in the data servers 300. At this time, two or more file storage requesters 110 generated in the client terminal 100 may perform network communication with different data servers 300 to transmit and store at least some of the file data to and in the data servers 300. Therefore, the file data of the client terminal 100 may be distributed to and stored in the plurality of data servers 300.

The plurality of file storage requesters 110 may be sorted to have a sequence number thereof and may process the file data by a chunk unit. The file storage requesters 110 may each calculate a chunk number of file data which is to be processed, based on a sequence number allocated thereto, the number of file stripes, and the number of storage processing. A chunk number calculating method performed by each of the file storage requesters 110 may be expressed as the following Equation (1):

next-processed file data chunk number=first chunk number (i.e., sequence number)+number of file stripes*number of storage processing (1)

To provide a more detailed description, file data may be sequentially input by a predetermined size unit (i.e., chunk) to an input buffer 120 of the client terminal 100. Also, when data having a predetermined size or more is input to the input buffer 120, the file storage requester 110 may take out a file data chunk from the input buffer 120 and may transmit and store the file data chunk to and in the data server 300. In this case, the input buffer 120 may sequentially output file data in a sequence (i.e., a chunk number sequence) in which the file data is inserted. That is, as illustrated in FIG. 2, the file data chunk may be output from the input buffer 120 in a number sequence of “F1, F2, F3, . . . ”. For reference, the input buffer 120 may use a circular queue, a first-in first-out (FIFO) queue, and/or the like.

In FIG. 2, it is illustrated that when the number of file stripes is set to 2, two file storage requesters 110-1 and 110-2 are generated in the client terminal 100. That is, the file storage requester 110-1 may transmit and store file data chunks to and in a data server 300-1, and the file storage requester 110-2 may transmit and store file data chunks to and in a data server 300-2. The file storage requesters 110-1 and 110-2 may request information about the data servers 300-1 and 300-2, where file data is to be stored, from the metadata server 200 to obtain the information. A sequence number of the file storage requester 1 110-1 may be 1, and thus, based on Equation (1), the file storage requester 1 110-1 may transmit and store file data chunks “F1, F3, F5, F7, . . . ” among file data chunks, stored in the input buffer 120, to and in the data server 1 300-1. Likewise, a sequence number of the file storage requester 2 110-2 may be 2, and thus, the file storage requester 2 110-2 may transmit and store file data chunks “F2, F4, F6, F8, . . . ” to and in the data server 2 300-2. In this manner, by using the file storage requester 1 110-1 and the file storage requester 2 110-2, file data chunks may be stored in parallel in two data servers (i.e., the data server 1 300-1 and the data server 2 300-2). For example, in a first transmission sequence, the file storage requester 1 110-1 and the file storage requester 2 110-2 may respectively transmit and store F1 and F2 to and in the data server 1 300-1 and the data server 2 300-2 in parallel.

The distributed file system 10 according to an embodiment of the present invention may distribute files in parallel, based on a file data storage request speed of an application of the client terminal 100 and an actual data storage speed at which actual data is stored in the data server 300.

In detail, as described above with reference to FIG. 2, file data may be input to the input buffer 120 by executing the application of the client terminal 100, and when the file data is output from the input buffer 120 according to the storage performance of the data server 300, a data input speed and a data output speed may be calculated based on the amount of processed data and a processing duration. In this case, if the data input speed is higher than the data output speed, the client terminal 100 may additionally generate a new file storage requester and may increase the predetermined number of file stripes by ones, thereby allocating the increased number of file stripes as a sequence number of the new file storage requester.

For example, if the data input speed is higher than the data output speed, as in FIG. 3, the client terminal 100 may additionally generate one file storage requester and may calculate 3 by adding 1 to 2 which is the current number of file stripes by ones, thereby allocating 3 as a sequence number of the one file storage requester. Also, the client terminal 100 may increase, by 1, information about the number of file stripes, included in metadata corresponding to a corresponding file, in the metadata server 200 and may be allocated a new data server from the metadata server 200. Therefore, a connection between a file storage requester 3 110-3 newly generated in the client terminal 100 and a newly allocated data server 3 300-3 may be established.

In detail, the file storage requester 2 110-2 which has the previous number (i.e., 2) of file stripes as a sequence number may take out the file data chunk F2 from the input buffer 120 to store the file data chunk F2 in the data server 2 300-2, and then, the file storage requester 1 110-1, the file storage requester 2 110-2, and the file storage requester 3 110-3 may sequentially distribute and store the file data chunk F3 and the other file data chunks to and in the data server 1 300-1, the data server 2 300-2, and the data server 3 300-3 in parallel. At this time, as the number of file stripes is set to 3, the file storage requester 1 110-1 may store the file data chunks F3 and F6 in the data server 1 300-1, the file storage requester 2 110-2 may store the file data chunks F4 and F7 in the data server 2 300-2, and the file storage requester 3 110-3 may store the file data chunks F5 and F8 in the data server 3 300-3.

It is assumed that as in FIG. 2, in a first storage processing sequence, the file storage requester 1 110-1 and the file storage requester 2 110-2 transmits and stores F1 and F2 in parallel, and then, as in FIG. 3, the first storage processing sequence is executed based on a change in number of file stripes. In this case, in the first storage processing sequence based on the change in number of file stripes, the file data chunks F3, F4 and F5 may be stored in three the data servers 300-1, 300-2 and 300-3 in parallel. Therefore, the file storage performance of the distributed file system 10 is further enhanced than a case where the number of file stripes is 2, thereby enhancing the execution performance of an application which has issued a request to store file data.

In this manner, in the distributed file system 10, the number of storage parallelization of file data may increase based on the data input speed and the data output speed, and thus, the data output speed of the input buffer 120 may increase, thereby preventing file data from being lost due to an overflow of the input buffer 120. In a case where a difference between an input speed at which file data is input to the input buffer 120 and an output speed at which the file data is output from the input buffer 120 is very large, since a capacity of the input buffer 120 is insufficient, a file data storage request cannot be received from an application despite the increase in number of storage parallelization. In this case, execution of a client application may be stopped. However, since large-scale data (big data) such as scientific data is generated for several hours, the loss of some data included in a large amount of total data does not greatly affect an analysis result of the total data. Therefore, when distributedly storing large-scale data such as scientific data, the distributed file system 10 according to an embodiment of the present invention may allow the loss of some data, thereby preventing the stop of an application that generates data.

In detail, when the input buffer 120 is fully filled by a specific threshold value or more, the client terminal 100 may delete a file data chunk, which is to be output next, from the input buffer 120. For example, file data chunks may be continuously deleted so that 50% of a data storage space of the input buffer 120 is maintained as an empty space. In this case, in order for deleted file data chunk numbers not to be successive, file data chunks may be deleted at certain time intervals. Therefore, when there is no processing target chunk number in the input buffer 120, the file storage requester 110 may store, instead of an original file data chunk, a predetermined loss pattern chunk in the data server 300. For reference, loss pattern chunk data may be a default data chunk and may be input by the user or may be previously set as arbitrary data.

In FIG. 3, it is illustrated that the file storage requester 2 110-2 and the file storage requester 1 110-1 check that the file data chunks F7 and F9 which are to be stored in a current storage sequence are not stored in the input buffer 120, and instead of the file data chunks F7 and F9, pieces of loss pattern chunk data respectively pre-stored in the data server 2 300-2 and the data server 1 300-1 are stored.

FIG. 4 is a diagram for describing a component of metadata when changing file striping according to an embodiment of the present invention.

In an embodiment of the present invention, metadata may include the total number of chunks of a file, loss pattern chunk data that is data which is to be alternatively stored when an arbitrary file data chunk is lost, the number of stripe lists indicating the number of file stripes which are used when storing file data, and information (i.e., the number of file stripes, a first chunk number, and a last chunk number) about each of stripes.

Referring to FIG. 3 for example, the total number of chunks may be 10, and the number of stripe lists may be 2. In first stripe information, the number of file stripes may be 2, a first chunk number may be 1, and a last chunk number may be 2. In second stripe information, the number of file stripes may be 3, a first chunk number may be 3, and a last chunk number may be 10.

Hereinabove, as described above with reference to FIGS. 1 to 4, the client terminal 100 according to an embodiment of the present invention may act as a high-performance distributed storage apparatus that enhances the distributed performance of the distributed file system 10 by changing file striping, based on a file data input/output speed. In this manner, the client terminal 100 acting as the high-performance distributed storage apparatus may include a high-speed distributed storage controller (not shown). The high-speed distributed storage controller may control changing of striping and deletion of a file data chunk in connection with the file storage requester 110 and the input buffer 120.

The high-performance distributed storage apparatus (i.e., the client terminal) 100 according to an embodiment of the present invention may be implemented in a type that includes a memory (not shown) and a processor (not shown).

That is, the memory (not shown) may store a program including a series of operations and algorithms that perform high-speed distributed storage by changing file striping and deleting a file data chunk, based on the above-described file data input/output speed. In this case, the program stored in the memory (not shown) may be a program where all operations of distributedly storing file data the elements of the high-performance distributed storage apparatus 100 are implemented as one, or may be that a plurality of programs for separately performing operations of the elements of the high-performance distributed storage apparatus 100 are connected to each other. The processor (not shown) may execute the program stored in the memory (not shown). As the processor (not shown) executes the program, operations and algorithms executed by the elements of the high-performance distributed storage apparatus 100 may be executed. For reference, the elements of the high-performance distributed storage apparatus 100 may each be implemented as software or hardware, such as a field programmable gate array (FPGA) or an application specific integrated circuit (ASIC), which performs certain tasks. However, the elements are not limited to the software or the hardware. Each of the elements may advantageously be configured to reside in the addressable storage medium and configured to execute on one or more processors. Thus, each element may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

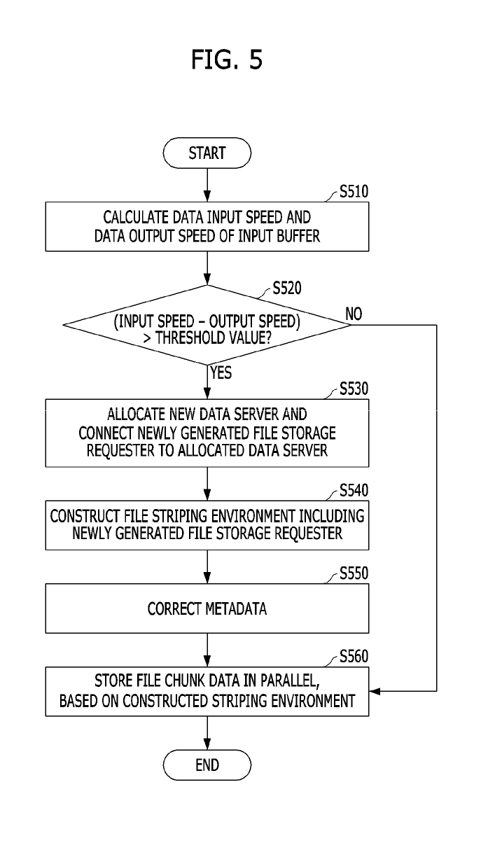

Hereinafter, a high-performance distributed storage method performed by the distributed file system 10 including the client terminal 100 according to an embodiment of the present invention will be described in detail with reference to FIGS. 5 to 7.

FIG. 5 is a flowchart for describing a file striping change operation when distributedly storing file data, according to an embodiment of the present invention.

Operations (S510 to S560) to be described below may be performed by the client terminal 100 and may be operations performed by the high-speed distributed storage controller (not shown).

As illustrated in FIG. 5, first, the client terminal 100 may calculate a data input speed and a data output speed, based on the amount of file data which is input to the input buffer 120 for a certain time and the amount of file data which is output from the input buffer 120 for a certain time in step S510.

In step S520, the client terminal 100 may determine whether a difference between the data input speed and the data output speed is greater than a specific threshold value.

In this case, the specific threshold value may be a speed difference value or a speed difference ratio.

When the difference between the data input speed and the data output speed is greater than the specific threshold value as a result of the determination, the client terminal 100 may be allocated a new data server 300 from the metadata server 200, may newly generate a file storage requester 110, and may connect the file storage requester 110 to the allocated data server 300 in step S530.

In this case, the newly generated file storage requester 110 may assign a sequence number obtained by adding 1 to the previous number of file stripes. Here, a sequence number of a file storage requester may denote a sequence in which the input buffer 120 outputs data to the file storage requesters 110.

Subsequently, in step S540, the client terminal 100 may construct a file striping environment including the newly generated file storage requester 110.

In detail, when a file storage requester 110 having a last sequence number based on the previous number of file stripes takes out data from the input buffer 120 and transmits the data to a corresponding data server 300, the client terminal 100 may lock an output of the input buffer 120. Also, re-setting may be performed starting from a first file data chunk stored in the input buffer 120, and unlike the related art, by applying the number of file stripes increased by 1, the client terminal 100 may issue a request to recalculate a file chunk number which is to be processed by each of the file storage requesters 110.

Subsequently, in step S550, the client terminal 100 may issue a request, to the metadata server 200, to change the number of stripes of a corresponding file.

In response to the request of the client terminal 100, the metadata server 200 may increase the number of stripe lists, insert a last chunk number of previous stripe information, generate new stripe information, and insert a first chunk number.

When changing of metadata by the metadata server 200 is completed, the client terminal 100 may unlock the output of the input buffer 120, and the file storage requesters 110 may respectively transmit file data chunks, output from the input buffer 120, to the data servers 300, thereby allowing the file data chunks to be stored in parallel in step S560.

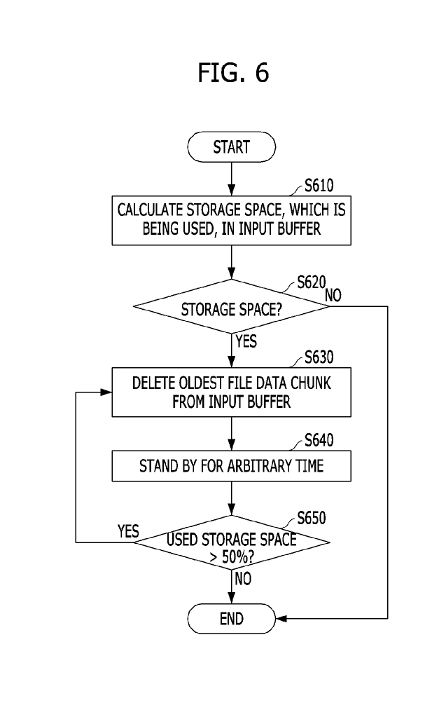

FIG. 6 is a flowchart for describing a file data chunk deleting operation when distributedly storing file data, according to an embodiment of the present invention.

Operations (S610 to S650) to be described below may be performed by the client terminal 100 and may be operations performed by the high-speed distributed storage controller (not shown).

First, when inputting or outputting file data to or from the input buffer 120, the client terminal 100 may calculate a storage space, which is being used, in the input buffer 120 in step S610.

Subsequently, in step S620, the client terminal 100 may determine whether the storage space which is being used in the input buffer 120 exceeds a predetermined specific threshold value.

In this case, the calculating of the storage space of the input buffer 120 and the determining of whether the storage space exceeds the specific threshold value may be performed periodically, at an arbitrary time, intermittently, or whenever data is input or output.

When the storage space which is being used exceeds the predetermined specific threshold value as a result of the determination, the client terminal 100 may delete the oldest file data chunk from the input buffer 120 in step S630.

Subsequently, the client terminal 100 may stand by for an arbitrary time in step S640, and may re-determine whether the storage space which is being used exceeds the predetermined specific threshold value (for example, 50%) in step S650.

When the storage space of the input buffer 120 exceeds the predetermined specific threshold value as a result of the redetermination, the client terminal 100 may return to step S630 and may repeat an operation of deleting the file data chunk.

On the other hand, when it is determined in each of steps S620 and S650 that the input buffer 120 is using a storage space less than the specific threshold value, the client terminal 100 may end a deletion and determination operation. For reference, after the deletion and determination operation ends, as described above, operations (S610 to S650) may be automatically performed periodically, intermittently, or whenever an input/output is performed.

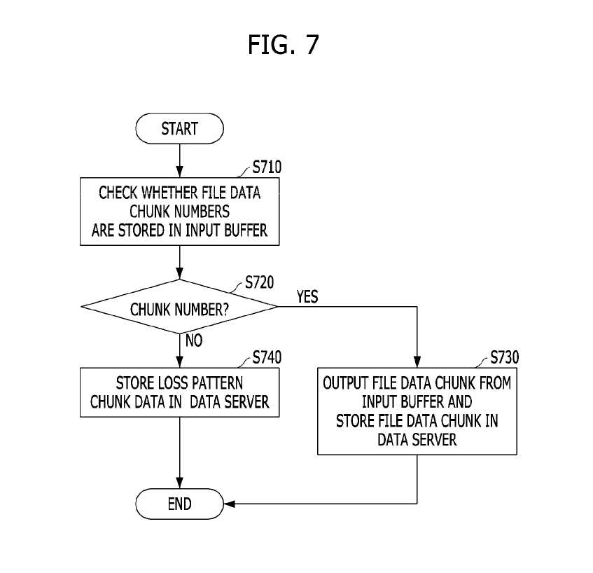

FIG. 7 is a flowchart for describing an operation of storing a file data chunk in a data server, according to an embodiment of the present invention.

Operations (S710 to S740) to be described below may be performed by the client terminal 100 and may be operations performed by the file storage requester 110.

First, in step S710, the file storage requester 110 may check whether file data chunk numbers which are to be processed are stored in the input buffer 120.

Subsequently, in step S720, the file storage requester 110 may determine whether the checked chunk numbers include a chunk number which is to be processed by the file storage requester 110.

When there is a corresponding chunk number as a result of the determination, the input buffer 120 may output a corresponding file data chunk, and then, the file storage requester 110 may transmit and store the corresponding file data chunk to and in a data server 300 connected to the file storage requester 110 in step S730.

On the other hand, when there is no file data having a corresponding chunk number as a result of the determination, the file storage requester 110 may alternatively transmit and store predetermined loss pattern chunk data to and in the data server 300 in step S740.

The method of distributedly storing file data at a high speed in the distributedly file system 10 including the high-performance distributed storage apparatus 100 according to the embodiments of the present invention may be implemented in the form of a storage medium that includes computer executable instructions, such as program modules, being executed by a computer. Computer-readable media may be any available media that may be accessed by the computer and includes both volatile and nonvolatile media, removable and non-removable media. In addition, the computer-readable media may include computer storage media and communication media. Computer storage media includes both the volatile and non-volatile, removable and non-removable media implemented as any method or technology for storage of information such as computer readable instructions, data structures, program modules, or other data. The medium of communication is typically computer-readable instructions, and other data in a modulated data signal such as data structures, or program modules, or other transport mechanism and includes any information delivery media.

The method and the system according to the embodiments of the present invention have been described above in association with a specific embodiment, but all or some of their elements or operations may be implemented with a computer system including a general-use hardware architecture.

The foregoing description of the present invention is for illustrative purposes, those with ordinary skill in the technical field of the present invention pertains in other specific forms without changing the technical idea or essential features of the present invention that may be modified to be able to understand. Therefore, the embodiments described above, exemplary in all respects and must understand that it is not limited. For example, each component may be distributed and carried out has been described as a monolithic and describes the components that are to be equally distributed in combined form, may be carried out.

As described above, according to the embodiments of the present invention, by increasing the number of data servers for storing file data according to a fast input speed of the file data, storage parallelism of the file data is enhanced, thereby increasing file data storage performance without stopping execution of an application.

Moreover, according to the embodiments of the present invention, if file data (i.e., scientific data) generated from a science application exceeds data storage performance based on the predetermined number of file stripes, by increasing the number of the file stripes, parallelization of chunk storage is augmented, thereby enhancing storage performance. Furthermore, when generation of file data increases rapidly, the file data is deleted by a chunk unit, and instead of the deleted file data, data input from a user is stored, thereby preventing a science application from being stopped in the middle of being executed for a long time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A high-performance distributed storage apparatus based on a distributed file system including a metadata server and a data server, the high-performance distributed storage apparatus comprising:
an input buffer, file data being input to the input buffer by a chunk unit;
two or more file storage requesters configured to output file data chunks stored in the input buffer and transmit and store the file data chunks to and in different data servers in parallel; and
a high-speed distributed storage controller configured to additionally generate a new file storage requester, based on a data input speed of the input buffer and a data output speed at which data is output to the data servers and delete at least one chunk of the file data stored in the input buffer, based on a predetermined remaining storage space of the input buffer.

2. The high-performance distributed storage apparatus of claim 1, wherein when the data input speed is more than a predetermined threshold value faster than the data output speed, the high-speed distributed storage controller additionally generates the new file storage requester, is allocated a new data server from the metadata server, and connects the new file storage requester to the new data server.

3. The high-performance distributed storage apparatus of claim 1, wherein
a sequence number of each of the two or more file storage requesters is set in order for another file storage requester not to overlap a chunk which is to be output from the input buffer, and
a chunk number which is to be output next is set based on a first chunk number in the input buffer, the sequence number, and number of storage processing.

4. The high-performance distributed storage apparatus of claim 1, wherein each of the two or more file storage requesters transmits and stores, instead of the deleted chunk, a predetermined default data chunk to and in the data server.

5. The high-performance distributed storage apparatus of claim 3, wherein the high-speed distributed storage controller generates the new file storage requester, updates and stores number of file stripes corresponding to the sequence number in the metadata server, and stores a last chunk number based on a result obtained by applying previous number of file stripes and a first chunk number based on a result obtained by applying the updated number of file stripes.

6. The high-performance distributed storage apparatus of claim 1, wherein
when the predetermined remaining storage space of the input buffer is less than a predetermined threshold value, the high-speed distributed storage controller deletes chunks in this sequence from an oldest chunk among pieces of file data stored in the input buffer, and
a next chunk number which is to be deleted is non-successive to a deleted chunk number.

7. A high-performance distributed storage method performed by a high-performance distributed storage apparatus based on a distributed file system including a metadata server and a data server, the high-performance distributed storage method comprising:
receiving and storing, by an input buffer, file data by a chunk unit;
outputting, by two or more file storage requesters connected to different data servers, file data chunks stored in the input buffer and transmitting the file data chunks to the connected data servers in parallel;
additionally generating, by a high-speed distributed storage controller, a new file storage requester to connect the new file storage requester to a new data server, based on a data input speed of the input buffer and a data output speed at which data is output to the data server;
re-setting, by the high-speed distributed storage controller, a file data chunk output sequence for a plurality of file storage requesters including the new file storage requester; and
applying, by the plurality of file storage requesters, a result of the re-setting to output and transmit the file data chunks stored in the input buffer to the connected data servers in parallel.

8. The high-performance distributed storage method of claim 7, wherein the additionally generating of the new file storage requester to connect the new file storage requester to the new data server comprises:
determining whether the data input speed is faster than the data output speed;
when the data input speed is more than a predetermined threshold value faster than the data output speed as a result of the determination, additionally generating the new file storage requester;
allocating, by the metadata server, the new data server;
connecting the new file storage requester to the allocated new data server.

9. The high-performance distributed storage method of claim 7, further comprising: after the receiving and storing of the file data by the chunk unit, by the high-speed distributed storage controller, assigning a sequence number in order for chunks, which are to be output from the input buffer, not to overlap each other for each of the plurality of file storage requesters,
wherein a chunk number which is to be output next for each of file storage requester is set based on a first chunk number in the input buffer, the sequence number, and number of storage processing.

10. The high-performance distributed storage method of claim 7, further comprising:
after the additionally generating of the new file storage requester to connect the new file storage requester to the new data server,
updating and storing number of file stripes corresponding to the sequence number in the metadata server; and
storing a last chunk number based on a result obtained by applying previous number of file stripes and a first chunk number based on a result obtained by applying the updated number of file stripes.

11. The high-performance distributed storage method of claim 7, further comprising: after the receiving and storing of the file data by the chunk unit, deleting at least one chunk of the file data stored in the input buffer, based on a remaining storage space of the input buffer.

12. The high-performance distributed storage method of claim 11, further comprising: after the deleting of the at least one chunk, by each of the two or more file storage requesters, transmitting and storing, instead of the deleted chunk, a predetermined default data chunk to and in the data server.

13. The high-performance distributed storage method of claim 11, wherein
the deleting of the at least one chunk comprises:
determining, by the high-speed distributed storage controller, whether the remaining storage space of the input buffer is less than a predetermined threshold value; and
when the remaining storage space of the input buffer is less than the predetermined threshold value, by the high-speed distributed storage controller, deleting chunks in this sequence from an oldest chunk among pieces of file data stored in the input buffer, and
a next chunk number which is to be deleted is non-successive to a deleted chunk number.
